(19) United States
(12) Patent Application Publication
(10) Pub. No.: US 2007/0000396 A1
(43) Pub. Date: Jan. 4, 2007

(54) Universal preparation and organization station/facility and airtight apparatus/appliance for the storage of baked goods and/or foodstuffs with a built in vacuum pump

(76) Inventor: Timothy Adam Kieck, Waukesha, WI (US)

Correspondence Address: TIMOTHY A. KIECK, 3632 STILLWATER CIRCLE, WAUKESHA, WI, 53189, US

(21) Appl. No.: 11/501,251

(22) Filed: Aug. 9, 2006

Related U.S. Application Data
(63) Continuation of application No. 10/389,603, filed on Mar. 17, 2003, now abandoned.
(60) Provisional application No. 60/429,020, filed on Nov. 26, 2002.

(51) Int. Cl. A23B 4/044

(52) U.S. Cl. 99/476

(57) ABSTRACT

The invention is an all in one apparatus/appliance system for the preparation and storage of baked goods and other foodstuffs. It provides a preparation station to prepare different types of goods for consumption, while also providing a universal storage area for baked goods and foodstuffs in general. It is equip with many features which allows storage and preparation to be easy, safe, effective, and convenient. It has a built in vacuum pump that expels air from within the apparatus to form a vacuum seal. This seal provides an air-free environment for foodstuffs and retards the formation of mold or other contaminants. This apparatus will aid in food organization and cleanliness.

### CROSS-REFERENCE TO RELATED APPLICATIONS

This application claims benefits from two provisional patents, application No. 60/429,020 filed on Nov. 26, 2002 titled “Vacuum sealed breadbox”, and 60/501,657 filed on Sep. 11, 2003 titled “Airtight Apparatus for the universal storage of baked goods with a built in vacuum pump”. This application also claims benefits from a disclosure document number 509451, to provide evidence of conception on the filing date of Apr. 8, 2002 describing the invention in this application.

### BACKGROUND OF THE INVENTION

This apparatus can be used by any person(s) who would like to keep baked goods and/or foodstuffs organized and/or fresh, while also providing a place to prepare them. This invention can be used by restaurants, hotels, and households, to name a few. This apparatus is designed for the use in the kitchen, or similar environment.

Currently, there are a no methods or devices that provide means for baked good preparation and/or organization and/or as an all in one system. This is also true for methods or devices that enable baked goods or foodstuffs to be stored in a single unit which is able to cater to all of their different characteristics. Using this invention will allow a user to store, prepare, and organize of all their baked goods and other foodstuffs with the use of one appliance. This will be more convenient and easier than existing means.

Also, there are a few methods used to keep food fresh, such as: vacuum packers and vacuum canisters. These methods only work with certain types of foods, and using these methods can squish and ruin the texture of certain goods. These methods also use plastic bags and/or separate vacuum units, which can be expensive and time consuming. They also don't provide a spacious storage area that would be necessary to store larger types and quantities of baked goods or foodstuffs such as: entire loaves of bread, a collection of bagels or English muffins, a dozen donuts, or a dozen hamburger or hotdog buns, or even a plate of cookies, or several slices of left over pizza. They also don't provide enough convenience as an all in one vacuum sealing system or preparation station for foodstuffs in general.

Using this apparatus will provide a universal storage area for all types of baked goods and/or similar foodstuffs such as: bread, bagels, buns, muffins, donuts, pastries, cereal, chips, cookies, and even leftovers, and it will allow these goods to be freshly stored in an efficient and economical fashion. This will aid in food organization and freshness of the goods.

In reference to U.S. Pat. No. 6,148,875; This patent uses a vacuum enclosure for the purpose of storing fruit, vegetables, or cold cuts and implementing the enclosure inside a refrigerator or freezer, and also for the use of food transportation. This system is not specifically designed for the storage of baked goods. It doesn't suit their needs in order to keep the baked goods in their most organized and freshest state. Baked goods are not intended to be stored in a refrigerator or freezer. Baked goods are sold on shelves at supermarkets and bakeries in a room-temperature environment, and should be stored the same after purchased.

This system also does not provide an economical way to store different types of foodstuffs in the same unit. The storage of different types of food together can cause cross contamination of different types of mold or bacteria, and this can lead to sanitation issues. The storage of different types of food together can also affect their flavor and aroma qualities. The only way to avoid this issue would be to use packaging or separate bags for different foods types which would defeat the purpose of having a fully exposed storage area. This would also not pose a solution to the damage the baked goods would receive inside a bag or package, when the vacuum pressure started to increase. This would mush or crush the baked goods. Also, storing baked goods in a refrigerator or freezer can degrade the original texture, taste, and aroma qualities. Some types of foodstuffs aren't meant to be refrigerated at all. For example, you wouldn't put cookies inside the refrigerator for later consumption.

Even if one would like to use such a system, they would have to install it themselves into their existing refrigerators or even go out and purchase a new refrigerator, with the system built in. This can be expensive, time consuming, and involve too much technicality.

The invention in this application implements the use of technology to increase its ease of use such as buttons, an LED display, and fully automated functions. It also provides the user with additional components and features to compliment the goods use, organization, and preparation.

This apparatus also is designed to be a portable apparatus that can be moved freely to any desired location to suit a vast amount of user needs such as: taking the unit to work, or connecting it during hotel breakfast hour, or even taking it to a picnic or cookout. It can also be built into the kitchen or similar environment.

### BRIEF SUMMARY OF THE INVENTION

This apparatus is designed to provide the user with a fast, easy, and convenient way to prepare and store baked goods and/or foodstuffs without the use of plastic vacuum bags, refrigeration, freezing, or a separate vacuum unit. It provides a spacious enclosure that would be necessary to store an adequate amount of baked goods and/or foodstuffs, and provides a designated storage place for baked goods and foodstuffs in general, which can aid in food organization and convenience.

Currently, there are a few methods used to keep food fresh, such as: vacuum packers, and vacuum canisters. These methods only work with certain types of foods, and using these methods can squish and ruin the texture of goods. These methods also use plastic bags and/or separate vacuum units, which can be expensive and time consuming. They also don't provide a spacious storage area that would be necessary to store larger types and quantities of baked goods and other foodstuffs such as: entire loaves of bread, a collection of bagels or English muffins, a dozen donuts, or a dozen hamburger or hotdog buns, or even a plate of cookies, or several slices of left over pizza. It also does not provide means for universal storage, preparation, and organization of baked goods or foodstuffs.

The object of the invention is to eliminate all existing food biases, and to provide the user with a simple, convenient, and proprietary apparatus/appliance to suit the needs of the baked goods and foodstuffs, to retain there freshness, to aid in food organization, while providing a place to prepare the goods.

### BRIEF DESCRIPTION OF THE DRAWINGS

FIG. 1—Front View of Apparatus and Components

FIG. 2—Front View of Apparatus with Additional Components and Toaster

FIG. 3—Inside View of Apparatus and Components

FIG. 4—Exploded View of Vacuum Pump and Components

FIG. 5—Front View of Additional Design and Components

FIG. 6—Exploded View of LED Display and Buttons

FIG. 7—Side View of Additional Design and Components

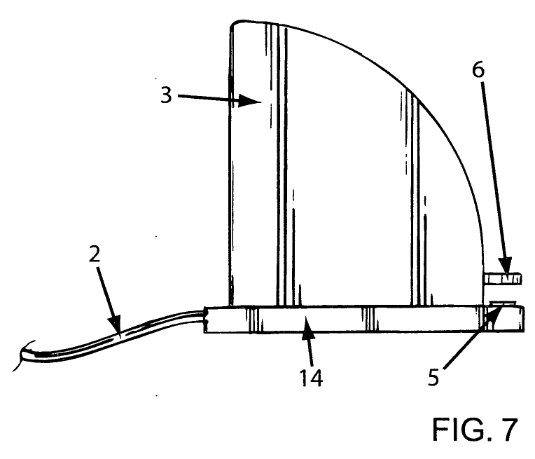

FIG. 8—Front View of Second Additional Design and Components

FIG. 9—Exploded View of a Type of Rubber Seal

FIG. 10—Second Exploded View of a Type of Rubber Seal

FIG. 11—Third Exploded View of a Type of Rubber Seal

FIG. 12—Front View of Apparatus with Latching System

FIG. 13—Exploded View of Latching System

FIG. 14—Exploded View of Manual Vacuum Pump System

FIG. 15—Front View of Apparatus with Manual Vacuum Pump Button and Clasps

FIG. 16—Front View of Apparatus with Manual Vacuum Pump Lever and Valve

FIG. 17—Back View of Apparatus and Hinges

FIG. 18—Basket View

FIG. 19—Electric Circuit View

FIG. 20—Built-In Kitchen Arrangement View

### DETAILED DESCRIPTION OF INVENTION

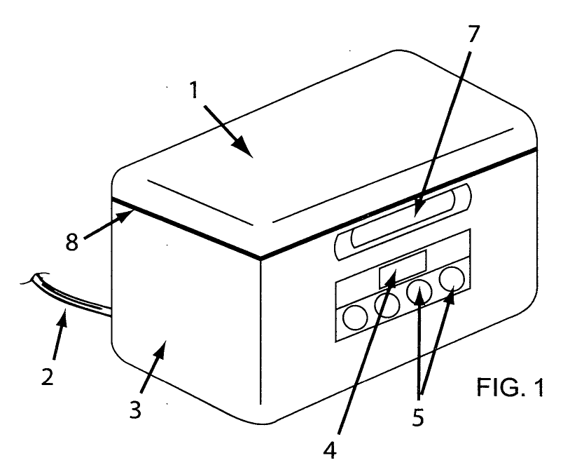

In reference to FIG. 1; The apparatus is composed of a contoured enclosure (3) with a conforming lid (1) or door (12). This lid (1) or door (12) used in combination with a rubber gasket (8) will form an air-tight seal. This enclosure (3) is used to house the goods for storage. A vacuum pump (17) is used to expel air from within the enclosure (3) to form a vacuum seal. This will keep the goods fresh and retard the formation of molds and other contaminants. There can also be multiple enclosures (3) and lids (1), which will provide several separate storage areas. This can be useful for storing different types of goods all in the same unit without having to open and close the same enclosure (3).

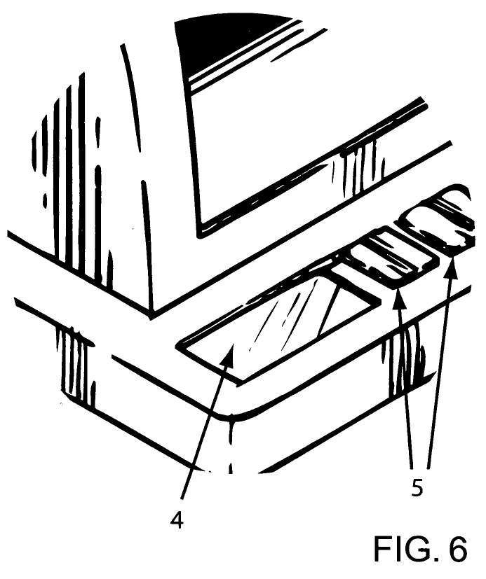

In reference to FIG. 6; The apparatus will include buttons (5), levers, or switches and an LED display (4) that will allow the user to visualize and initiate functions of the unit, such as: activating or deactivating the vacuum pump (17), setting, displaying, or adjusting the date, time, alarm, timer, or pressure, and can also be used to activate lights to enable the LED display (4) to be more visible, to name a few.

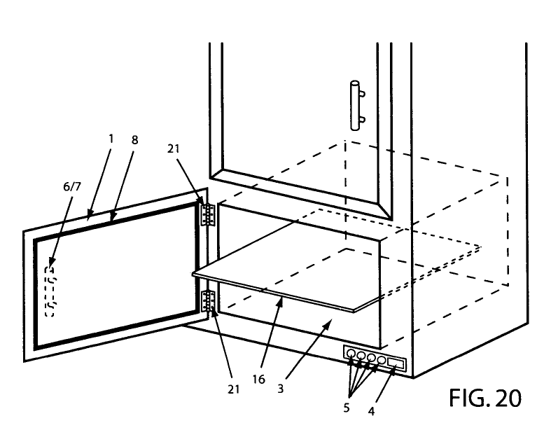

In reference to FIG. 20; The apparatus can be built-in to the kitchen or other environment. This will enable the complete setup to be installed directly into cabinet arrangements as well as other possibilities. This will keep foods permanently organized and will streamline the environment.

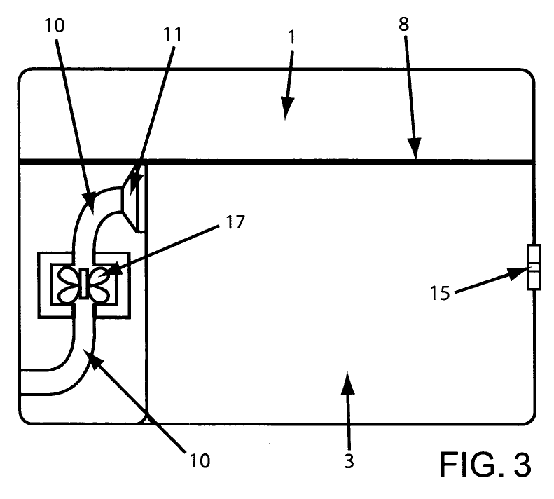

In reference to FIG. 3; The apparatus can use a vacuum pump or similar suction mechanism to expel the air from within the enclosure (3). This pump (17) can either be automatic or manual.

In reference to FIG. 3; The vacuum pump (17) is kept separate from the enclosure (3) and connected to the enclosure (3) by the use of tubing (10). This will make sure the vacuum pump (17) will not interfere with the storage space of the enclosure (3), and so the vacuum pump (17) will not be exposed to the goods. It can also be housed in a manner which enables it to operate quietly and so there is no vibration while the pump is activated.

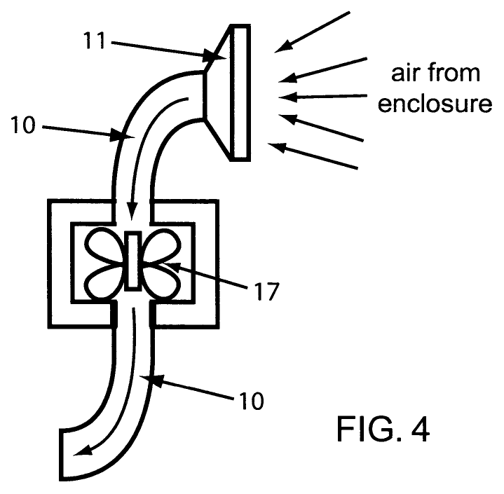

In reference to FIG. 4; When the vacuum pump (17) is activated, it causes suction to occur. This suction draws air from the enclosure (3) by the use of tubing (10). This air may need to be cleaned using an air filter (11). This will make sure that the air taken from the enclosure (3) won't damage the vacuum pump (17) in case there are crumbs or particles present.

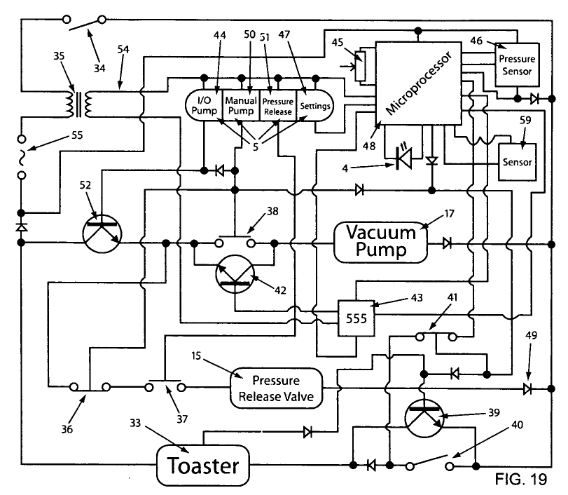

In reference to FIG. 19; The vacuum pump (17) automation can be controlled in different ways. One for example, by user automation, whereas the user can press a button (5), thus turning the power (55) on to the vacuum pump (17), or another, by allowing an electrical circuit to gain precedence over its control. This automation can be displayed on the LED display (4) to inform the user the function is in automation. It could also be turned on by a timer (43) at certain times or intervals. These are just a few possibilities.

In reference to FIG. 19; The vacuum pump (17) automation can be controlled by a timer, pressure sensor, or and/or vacuum switch. These components will detect when the appropriate amount of vacuum pressure has been achieved within the enclosure (3). When using a timer (43), this can be done by calculating the strength and speed of the vacuum pump (17), and how much air is inside the enclosure (3), or by computing the electrical signals given off by a pressure sensor or vacuum switch (46).

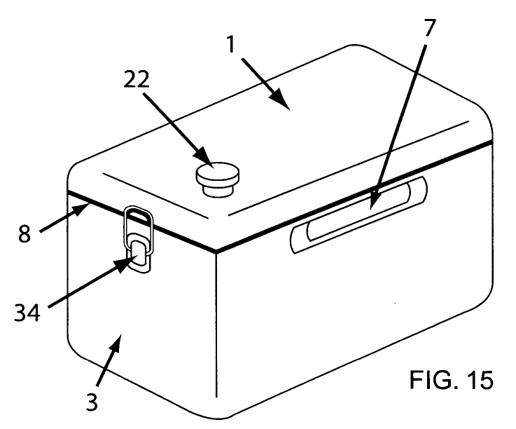

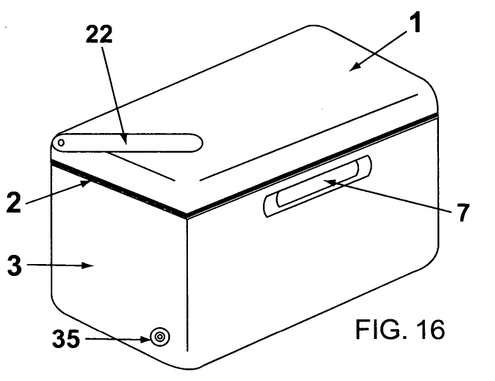

In reference to FIG. 15 and 16; The invention can also include a manual vacuum pump or similar suctions mechanism to help expel air from within the enclosure (3). This pump can be activated by hand, using a button (22) or lever (24). The button (22) or lever (24) can be pressed up and down or pulled back and forth to create suction which will expel the air from within the enclosure (3). Pressing the button (22) or pulling the lever (24) repeatedly will make the vacuum stronger. This will allow the user to adjust the pressure to their own personal preference.

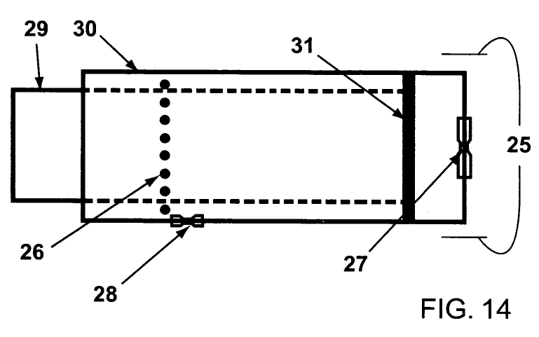

In reference to FIG. 14; The mechanism (25) that creates the suction can use two cylinders. One cylinder (29) will be slightly smaller in diameter and in length, and it will be inside of the larger cylinder (30). There will be a rubber ring (31) around the bottom rim of the smaller cylinder (29) that will put pressure against the outer cylinder (30). The larger cylinder (30) will be connected to the enclosure (3) which will be separated by a unidirectional valve (27). The suction will be created when the inner cylinder (29) is pulled back and forth, because the rubber ring (31) will form an air-tight seal within the outer cylinder (30), which will draw air through the unidirectional valve (27), thus creating a vacuum within the enclosure (3).

In reference to FIG. 14; Towards the top of the outer cylinder (30), there will be a ring of tiny holes (26) for air to be released. When the rubber ring (31) is pulled up past these holes (26), air can escape. After the air is released, there will be another automated valve (28) that will open to eliminate the pressure within the manual pump system (25) when the rubber ring (31) is pressed back down past the holes (26). This valve (28) can be rigged with the button (22) or lever (24) itself. For example, when the button (22) or lever (24) is pressed or pulled, the valve (28) will be open, and when the button (22) or lever (24) is released or pushed, the valve (28) will be closed. The inner cylinder (29) will be rigged to move back and forth by the use of the button (22) or lever (24) as well.

This suction mechanism (25) can be housed inside the lid (1), or mounted underneath. It could also be housed inside the walls of the enclosure (3) as well as being mounted inside the enclosure (3). It should be housed or mounted in an efficient place as to not interfere with the goods being kept inside the enclosure (3) as well as making it a convenience to operate. The mechanism (25) can be made to be stationary within the enclosure (3) or its walls, or to be removable as part of the entire lid (1) section.

In reference to FIG. 1; The suction mechanism (25) doesn't have to be built into the apparatus at all. In this case, the enclosure (3) or lid (1) can simply have a built-in unidirectional valve (35) so that the mechanism (25) or other external vacuum source can be connected to pump the air out of the enclosure (3).

In reference to FIG. 1; This apparatus will get its power (55) from a standard 120 volt power cord (2). This electricity will be used to power the components of the apparatus. This power cord (2) could be detachable, or could also be stored inside the enclosure (3). This will help when the apparatus is being moved.

An electrical circuit (56) will be used in the apparatus. This will control a variety of different functions and calculate a variety of different factors. The electrical circuit (56) will be used as the control center for the entire apparatus. This circuit (56) will be made up of a variety of different electrical components such as: timers (43), pressure sensors (46), spoilage or environment sensors, actuators, switches, buttons (5), levers, and an LED Display (4), as well as other circuit components. These components will be regulated by the use of circuit board(s) and by using basic electrical circuit board components such as: relays, diodes, resistors, capacitors, potentiometers, and ICs (integrated circuits). All of these electrical components used together will control the apparatus functions such as: turning the vacuum pump (17) on and off, releasing the pressure within the enclosure (3), displaying the date and time, displaying the automation of functions, allowing user automation over the apparatus functions, as well as controlling the functions without the need for user automation, to name a few. For example, when the user would like to open the enclosure (3) to gain access to the baked goods, they would press a button (5), which would activate the vacuum release valve (15), thus releasing the vacuum pressure within the enclosure (3). For example, when the user closes the lid (1), this will trigger the vacuum pump (17) to turn on, thus resealing the enclosure (3) with pressure. For example, when a user would like to adjust the time or date, they would press the apparatus's buttons (5), thus changing the time or date reading on the LED display (4). These are just a few of the possibilities.

In reference to FIG. 19; The circuit (56) is powered by 120 VAC (55) which is supplied by a standard plug (2) which is plugged into a standard household outlet 120 VAC outlet. The circuit (56) can be turned on by a main I/O switch (34) which is used to complete the circuit (56) which allows the components to have access to the power (55). Once the components receive power (55) the apparatus's functions can be used.

In reference to FIG. 19; The functions of the toaster, microwave, or heating element (33) can be initiated by activating the toaster lever (58), just like a normal toaster would be used. The toaster (33) can be hooked up to the circuit (56) without interfering with any operations of the rest of the circuit (56).

In reference to FIG. 19; Components that may require lesser amounts of current may get their power (54) from a transformer (35). The transformer (35) can reduce the current for this purpose. This current can be used to power things such as microprocessors (48) and other integrated circuits (46)(43)(5), which require less power. The buttons (5)(44)(50)(51)(47) can also use this power (54) to initiate functions. Other areas of the circuit (56) may also use this power (54).

In reference to FIG. 19; The microprocessor (48) will be used to control functions of the entire circuit (56). It can receive signals from the pressure sensor (46), 555 timer (43), and other components. It receives and computes these signals to control apparatus functions. It can also be used in combination with a potentiometer (45) and the buttons (5)(44)(50)(51)(47) to control various functions like turning the vacuum pump (17) on or off, to release pressure from the enclosure (3), and to change internal settings that control things such as: date, time, alarm(s), pressure, vacuum speed and duration, and LED's, to name a few. It could also hold data and/or also function as memory. It can also be used for other reasons.

In reference to FIG. 19; An LED (4) can be used to display date, time, and the various use of functions. This LED (4) can remain lit at all times. With aid from the timer (43) and/or microprocessor (48), or other components it can display the use of various functions. For example, it can display when the user has achieved the desired amount of vacuum pressure while depressing the pressure release button (15), or it can display when the vacuum pump (17) is turned on. It could also display the pressure reading inside the enclosure (3). It could also be used to provide visibility inside the enclosure (3). These are just a few possibilities. It can also be used for other reasons.

In reference to FIG. 19; The pressure sensor (46) is used to determine the appropriate amount of pressure within the enclosure (3). When used in combination with the microprocessor (48) or other components, it can also be used to control the amount of pressure the enclosure (3) receives. It can help determine whether the seal (8) is leaking pressure by displaying it with an LED (4). With the aid of a potentiometer(s) (45), the pressure of the vacuum seal (8) within the enclosure (3) could be adjusted. It can also be used to tell the vacuum pump (17) when to shut off, as well as automatically turning on the vacuum pump (17) in a case where the pressure drops below a reasonable level. The apparatus can make use of many logistics that can be determined by the use of a pressure sensor(s) (46). These logistics can enable many useful features for the unit while also providing means for automation. It can also be used for other reasons.

In reference to FIG. 19; The integrated timer circuit, 555 timer (43), or similar circuit is used to keep time on various elements such as: date, time, alarms, timing, and pressure, just to name a few. When used in combination with a microprocessor (48), it can aid in determining many variables and factors which can be used to apply functions used by the apparatus. For example, it can be used to determine the appropriate amount of time for the vacuum pump (17) to remain on or in use. The circuit (55) can use more than one of these circuits (56). It can also be used for other reasons.

In reference to FIG. 19; The latching system (20) can be used as a switch, which completes the circuit (56), thus enabling the apparatus's functions. If the latching system (20) is open, the circuit (56) is off. If it is closed, the circuit (56) is on. Furthermore, when the latching system (56) is open and closed, it can automate the use of the vacuum pump (17) and the pressure release valve (15). For example, when the apparatus is closed, the vacuum pump (17) is activated which will repressurize the enclosure (3). Also, when the latching system handle (20) is depressed, it can activate the pressure release valve or solenoid valve (15), which will release the pressure and open the apparatus. If the latching system (20) is open it means that the enclosure (3) is open and the apparatus is in use which can disable all unwanted operations from being used at inappropriate times. There can be variations to this feature.

In reference to FIG. 19; The vacuum pump (17) can be turned on or off by the use of the I/O pump button (44). This button (44) can shut off any or all use of the vacuum pump (17). This is a useful feature when a user would like to use the enclosure (3) for storage without using the pump (17). For example, if the user will be opening and closing the unit many times sequentially, they could easily just turn the pump (17) off. This would be more efficient than allowing the unit to repressurize between each use. For example, this feature could be used at breakfast time, where use of the unit would be repeatedly opened in a short duration. This button (44) can also be used as a safety or security feature. For example, the pressure sensor (46) has detected a leak in the seal, so the main power (55) to the vacuum pump (17) can simply be turned off to save electricity and resources. It can also be used for other reasons as well.

In reference to FIG. 19; The manual pump button (50) can be used to switch the vacuum pump (17) on for a desired duration. This button (50), when depressed will manually turn on the vacuum pump (17). It can override the I/O pump button (44). This is especially useful when the vacuum pump (17) is turned off. This will enable the user to be able to seal the enclosure (3) at will. This function can also be used in combination with the microprocessor (48), pressure sensor (46), and 555 timer (43) to determine when the enclosure (3) has achieved the desired level of pressure. This button (50) will turn on the vacuum pump (17) only for the duration that the button (50) is being depressed. It can also be used for other reasons as well.

In reference to FIG. 19; The pressure release button (51) can be used to release the pressure from within the enclosure (3). This button (51) will enable a user to release the pressure without having to actually open the lid (1). It can also be used as a safety or security feature that is used to release the pressure within the enclosure (3) in the case that the handle or latching system (20) malfunctions. It can also be used for other reasons.

In reference to FIG. 19; The settings button (47) can be used to display or change various features of the unit. For example, it can be used for changing the date or time, or it can be used to change internal settings for the desired pressure level, or to deactivate the spoilage alarm. It could also be used to turn on an LED (4) inside the enclosure (3). These are just a few possibilities. The unit could also use other buttons for various use of features and functions.

In reference to FIG. 19; The diodes (49) function as gates that only allow electricity to flow in certain directions. These gates create logic that enables certain functions of the unit to remain constant. They can also be positioned in other places to create other useful logistics for the circuit (56).

In reference to FIG. 19; Gate (52) can be used to turn power (55) to the vacuum pump (17) on or off. It is controlled by the I/O pump button (44). If the button (44) is on, the power (55) to the vacuum pump (17) will remain constant, and if the button (44) is off, the vacuum pump (17) won't be able to get power (55). This gate (52) can be opened by the use of the manual pump button (50), which will open the gate (52) for the duration of the button being depressed. This gate (52) can be made with a transistor, or similar component, used to create logistics.

In reference to FIG. 19; Gate (42) can be used to turn power (55) to the vacuum pump (17) on or off, except it is used in automation and in combination with the latching system (20). When the unit is closed, the circuit sends a signal to the microprocessor (48) which will compute the interval as to which the gate (42) will remain open. This gate (42) can be made with a transistor, or similar component, used to create logistics.

In reference to FIG. 19; Gate (39) can be used as an override for the latching system (20). It can be activated by the manual pump button (50), which will open the gate and allowing the vacuum pump (17) to receive power (55). It can also be activated by the microprocessor (48) for various reasons and/or overrides. This gate (39) can be made with a transistor, or similar component(s) used to create logistics.

In reference to FIG. 19; Switch (38) can be used to provide means for the vacuum pump (17) to receive power (55). This switch (38) is activated by the manual pump button (50). Similar switch (37) is used to provide means for the pressure release valve (15) to be activated by the pressure release valve button (51).

In reference to FIG. 19; Switch (36) can be used to provide means for power (55) to remain constant. When used in combination with switch (37), it can provide logistics to turn power (55) on and off to the pressure release valve (15).

In reference to FIG. 19; Switch (41) can be used to provide means for power (55) to remain constant. When used in combination with the microprocessor (48), it can provide logistics to turn power (55) on and off to the vacuum pump (17).

Components can be substituted with similar components that serve the same purpose(s). The orientation to which the components are connected may be different as well. Many logistics can be made by the use of these components. These logistics can be used for various other reasons and to create features appropriate for the apparatus.

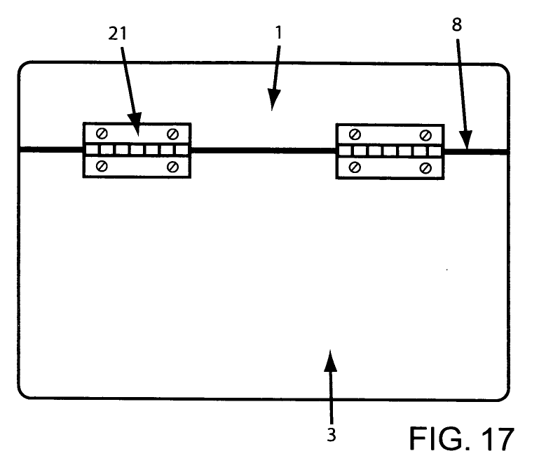

Gaining access to the enclosure (3) can be done using several methods. The lid (1) will need to be opened by the user to access the goods housed within the enclosure (3). In reference to FIG. 17; the lid (1) can either be detachable or it can be connected to the rest of the apparatus using hinges (21). In either case, the apparatus can use a handle (6) to enable the user to apply leverage to the lid (1), thus making it easier to open the enclosure (3).

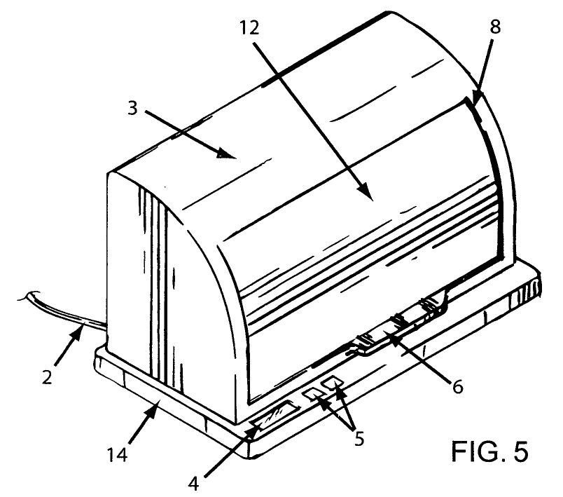

In reference to FIG. 5; The user can gain access to the enclosure (3) using a sliding door (12). This can be made with contoured plastic or other material, or with a section that has foldable characteristics. This sliding door (12) can also benefit from the use of a handle (6). This door can also be transparent.

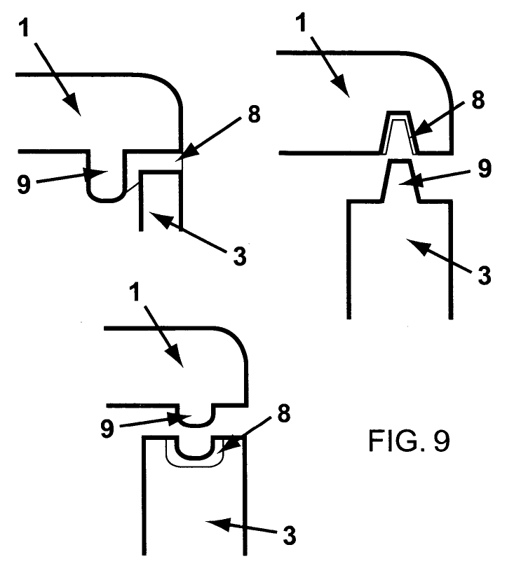

In reference to FIG. 9; In order for the enclosure (3) to contain the vacuum pressure, the seal must be air-tight. This can be achieved using a rubber seal (8). When the lid (1) or sliding door (12) is in a closed position, the rubber seal (8) will form an air-tight gasket for the enclosure (3). This rubber seal (8) can be attached to either the lid (1) or to the rim of the enclosure (3). When vacuum pressure is applied to this rubber seal (8), it will contain the pressure and keep the enclosure (3) vacuum sealed, thus providing an air-free environment for the goods to be kept. This rubber gasket (8) will be FDA approved to be in contact with foodstuffs and be safe for cleaning as well. The seal is designed to be simple and practical. The lid (1) or door (12) of the apparatus will be opened and closed frequently, thus making the need to keep the seal simple and easy to open.

In reference to FIG. 9; Either the underside of the lid (1), or the perimeter of the enclosure (3) will contain a protruding lip or rim (9). This lip or rim (9) will be used to receive the lid (1) so that seal forms a snug air-tight fit each time it is closed. The notch or opening of the rubber seal (8) will be slightly smaller than the lip or rim (9), so that when the lip or rim (9) is inserted into the rubber seal (8), the rubber seal (8) will squeeze and grip the lip or rim (9). The pressure or tightness created between the lip or rim (9) and the rubber seal (8) will aid in this grip, which will provide an air-tight seal for the enclosure (3).

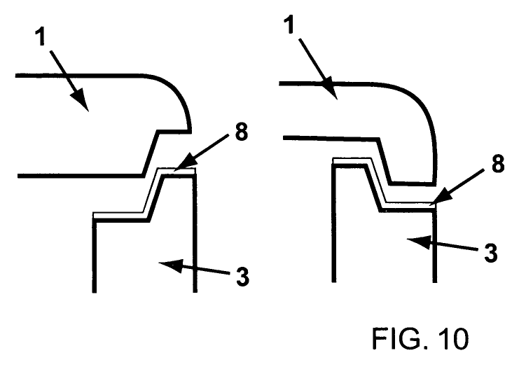

In reference to FIG. 10; The lip or rim (9) is a flat section that puts pressure on the rubber seal (8) when the lid (1) is closed. This lip or rim (9) can have a slightly larger perimeter than the inside perimeter of the enclosure (3), thus causing significant pressure between the lip or rim (9) and the rubber seal (8). This method can be compared to how a beverage cooler would close.

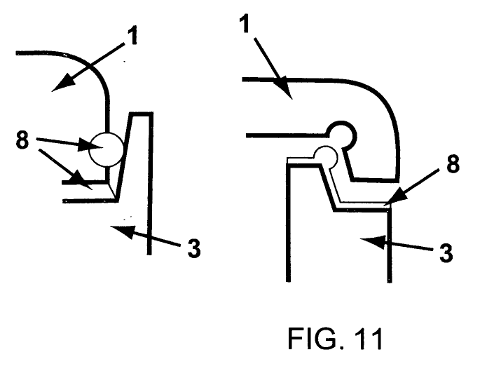

In reference to FIG. 11; Added security could be added to the lid (1) by having a notch cut into the lid (1), that would receive a bulge of rubber seal (8). The rubber seal (8) would be squished into the notch by the pressure of the lid (1) being closed. The lid (1) would be held securely closed because the rubber sea! (8) won't slip out of place unless a significant amount of force is applied to open the lid (1).

In reference to FIG. 11; A rubber seal (8) is formed around the perimeter of the lid (1). When the lid (1) is closed, it will slide into the top of the enclosure (3). The inner rim of the enclosure (3) will be angled so that the lid (1) can be received with ease. When downward pressure is applied to the lid (1), it will create pressure between the rubber seal (8) and the inside of the enclosure (3), thus creating an air-tight seal capable of containing vacuum pressure. The shape(s) of the seal (8) can vary depending on the needs of the apparatus or enclosure (3).

An air-tight seal can also be achieved without a rubber seal (8). The pressure between the lid (1) and the enclosure's (3) walls could be strong enough to contain vacuum pressure. This method can be compared to how a beverage cooler would close.

In reference to FIG. 3 and 19; When the vacuum seal needs to be released, the apparatus can use a vacuum release valve or release valve system (15). This can be controlled by a button (5) or similar mechanism that the user can activate at will. Upon activation, a valve (15) will open to allow air to flow into the enclosure (3) and thus, releasing the vacuum pressure and enabling the lid (1) or door (12) to be opened safely and easily. The vacuum release valve (15) may or may not make use of the electrical circuit (56). This valve (15) may also use an air filter (11) to make sure the air is cleaned prior to entering the enclosure (3). This release valve or release valve system (15) can be separate from the rest of the other mechanisms, or it can be part of the latching system's (20) automation. For example, when the user presses or pulls the latching handle (7) to open the lid (1), the release valve (15) will open.

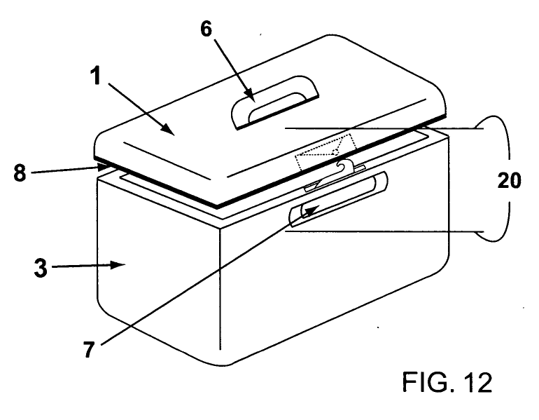

In reference to FIG. 12; since the rubber seal (8) grips the lip or notch (9) of the enclosure (3), using a latching mechanism or system (20) to aid in the release of the lid (1) or door (12) can help the user to open the enclosure (3) easily and safely, even after the vacuum pressure has been released. When pressed or pulled this mechanism (20) can pop the lid (1) or door (12) open. This mechanism (20) can also help hold the lid (1) or door (12) closed, and adds pressure between the rubber seal (8) and the lip or notch (9) of the enclosure (3).

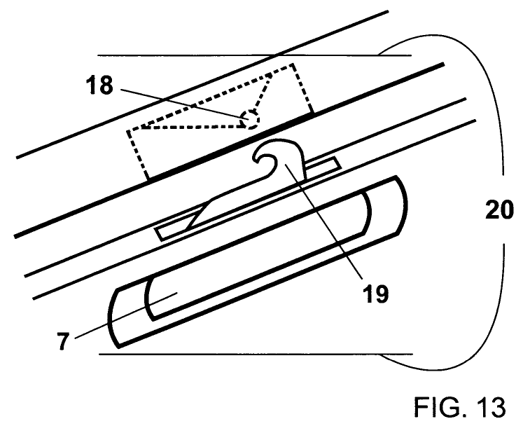

In reference to FIG. 13; The latching system (20) can simply be a hook (19) that is held shut by a pin (18). Either the hook (19) or pin (18) can be moved by pressing or pulling a lever or handle (7), which will cause the latch to open, thus lifting the lid (1) open. The lever or handle (7) can use a spring(s) to add leverage or resistance to the system. While the lid (1) is being closed, the hook (19) or pin (18) can simply slide into locked position without being depressed.

A lid (1) opening mechanism can be a part of the latching system (20). With the aid of some springs, the mechanism can pop open the lid (1) when the latching handle (7) is pressed or pulled.

The latching mechanism can also activate the vacuum release valve (15), which will allow air into the enclosure (3).

The entire system (20) can be completely automated by the pressing or a pulling the latching handle (7). When the latching handle (7) is pressed or pulled, it can release the pressure within the enclosure (3) via the release valve (15), while releasing the hook (19) from the pin (18) causing the spring to lift the lid (1) open for the user.

In reference to FIG. 15; Another version of a latching system can simply use clasps (34) or one large clasp (34) to secure the lid (1). The lid (1) may or may not use hinges (21) depending on the clasps (34) being on the sides of the enclosure (3), or one large clasp (34) in the front. There maybe variations to the latching system (20) or latching system orientation

The lid (1) or door (12) of the apparatus can be made of clear plastic. The lid (1) or enclosure (3) could also contain a clear window to allow visibility into the enclosure (3). This will enable a user to view the enclosure's (3) contents before unsealing it.

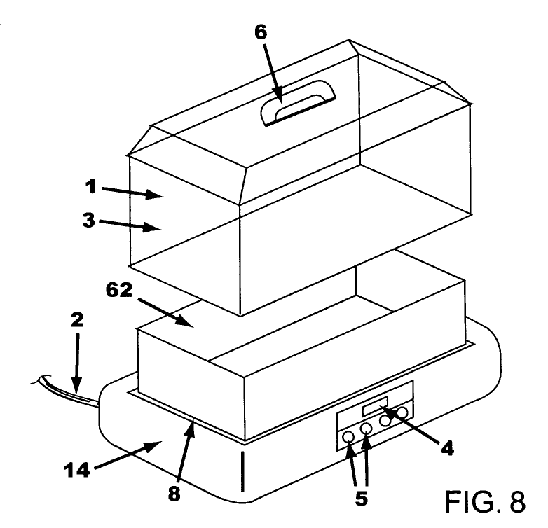

In reference to FIG. 8; The apparatus can have a lid (1) and an enclosure (3) act as one object. This will enable a user to lift up the entire enclosure (3) to gain access to the goods. This lid (1) or enclosure (3) can be made of clear plastic as well. The rubber seal (8) would be underneath the enclosure (3), thus allowing gravity to aid in the enclosure's (3) seal. The apparatus's components would be housed inside the base (14), or elsewhere, and to not interfere with the enclosure (3). A plastic casing (62) can be used around the inner rim of the enclosure (3). This will prevent goods from falling over when the enclosure (3) is opened, while providing guidance for the lid (1) or enclosure (3) when it's being closed.

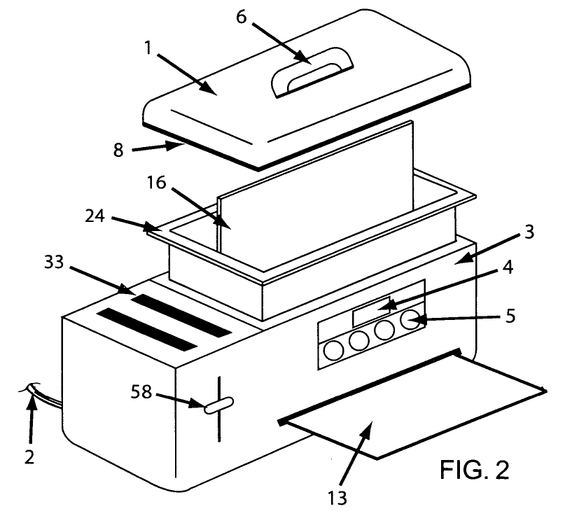

In reference to FIG. 2; The apparatus can include slide-out plastic separators (16). These simple pieces of plastic can help aid in food organization. These separators (16) will slide into a notch that is formed on the inside walls of the enclosure (3). They can be shorter than the height of the enclosure (3). This will ensure that plenty of air circulation can occur within the entire enclosure (3), and that when the vacuum pump (17) is turned on, the separators (16) won't deter the components from getting an accurate pressure reading or that the separators (16) aren't blocking any air paths into the air filter (11) or tubing (10). The separators (16) can also come in different sizes to enable the user to personalize the enclosure (3) to suit their needs. This will enable many possibilities for the enclosure to be organized in ways to suit many types of goods. The separators (16) can also be used as cutting tools for the goods. They could be tapered at one edge to provide a “sharp” edge for cutting. For example, you could cut your toast in half. This could come in handy when used in combination with the cutting board.

In reference to FIG. 2; This apparatus can also include a slide-out tray or slice. This item (13) can function as a cutting board or plate, so a user can slide this section out and provide a place to prepare the goods and to perform actions such as: making sandwiches, cutting bagels, or buttering bread, to name a few. This item (13) will ensure that counter-top or table surfaces will not get damaged by knives. It will also ensure that the crumbs or mess left from the preparation is not spilled onto the counter-top or table surfaces.

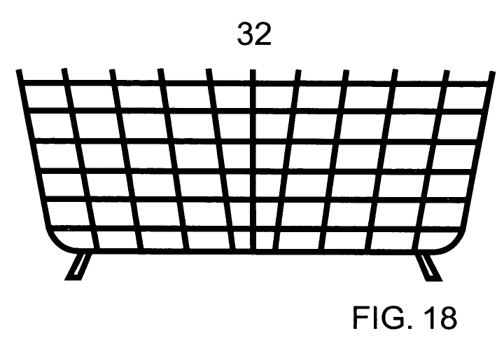

In reference to FIG. 18; The apparatus will also include ergonomically designed racks or baskets (32) for the inside of the enclosure (3). These baskets (32) can serve several purposes. It can keep the goods from coming in contact with the bottom of the enclosure (3). This will make sure that the goods do not come in contact with any crumbs that have fallen from the enclosure's (3) previous contents. It also can be used to suit the many types of shapes of the goods. For example, a basket (32) designed to hold a loaf of bread, or a basket (32) designed to hold a stack of English muffins or bagels, or a dish of cookies, or even cereal. They can be stackable for added convenience.

In reference to FIG. 2; The apparatus will also include a removable tray(s) (23) that fits inside the enclosure (3), or one that acts as the entire enclosure (3) itself. This tray (23) can be used for catching crumbs from the goods. When a user would like to empty the tray (23), they can simply slide it out of the enclosure (3), and dispose of the crumbs. This tray (23) will aid in food sanitation and cleanliness. This tray(s) can also be stackable for added convenience.

In reference to FIG. 2; This apparatus can also benefit from the combination of other household appliances such as: a toaster (33), toaster oven, or microwave, to name a few. The apparatus can have a built in toaster (33), toaster oven, microwave, or heating element which can provide the user with a one-stop station to prepare their baked goods, or other foodstuffs.

The apparatus and its components will be made mostly of plastic which can be formed by the use of plastic injection molding or similar plastic forming methods. This will provide a smooth and safe area for the goods to be stored, and to make an effective design enabling the apparatus to fit into most environments. The rubber seal (8) will need to be formed to suit the contours of the lip or notch (9). The electrical circuit (56) will be made using basic circuit components, circuit board(s), and electrical wiring.

What I claim as my invention is:

1: A complete all in one baked good/foodstuff preparation, organization, and storage station and/or facility, which is used as a universal place for good preparation, organization, and storage, wherein the apparatus is used to provide a universal storage place for all types of baked goods such as: bread, bagels, buns, muffins, donuts, and pastries, but not limited to any specific type of baked goods, and which can also be used for other foodstuffs such as: cereal, crackers, cookies and leftovers, but not limited to any type of foodstuffs, wherein the apparatus is designed exclusively for the preparation, organization, and storage of baked goods and other foodstuffs, which can or is intended to replace or substitute as a traditional bread basket for similar means of storage, while providing enhancements and added features to aid and to upgrade preparation, organization, cleanliness, and sanitation, which can be or is an appliance.

2: The apparatus of claim 1, which can be used to prepare goods for consumption such as: buttering bread, making sandwiches or toast, or cutting bagels, but not limited to any specific means.

3: The apparatus of claim 1, wherein the apparatus can be or is specifically designed to keep goods fresh and to retard the formation of mold and other contaminants, without the use of refrigeration, vacuum bags, or a freezer.

4: The apparatus of claim 1, whereas the apparatus can be or is able to be organized and rearranged in order to suit the needs of many different types of baked goods and foodstuffs, which is designed to provide sophisticated organization for baked goods and foodstuffs, and to provide a practical and streamlined method(s) for storage, preparation, and organization of goods.

5: The apparatus of claim 1, which can be comprised of:
(a) a contoured enclosure with air ports, which is used to store baked goods and foodstuffs, which is designed to be ergonomical in order to receive and store the goods delicately, with soft corners, and contours which will not distort the shapes or textures of the goods, which can be transparent;
(b) an automatic vacuum pump and/or system with air ports used to expel air from within the enclosure, which can be housed in the apparatus silently and without vibration or connected separately, and regulated by a timer, sensor, or circuit, or other means;
(c) tubing to connect the vacuum ports to the enclosure;
(d) air filters to clean the air before it enters the vacuum pump;
(e) a lid, door, or sliding door which can be transparent or contain a transparent window to allow visibility within the enclosure, or a transparent lid which can function as the enclosure itself, either of which can be equip with a handle and/or a latching handle, and shaped to form an air-tight seal within the enclosure;
(f) hinges which will connect the lid to the enclosure;
(g) a rubber gasket used to form an air-tight seal between the lid or door and the enclosure;
(h) an air actuator and/or vacuum release valve to release the vacuum pressure within the enclosure, which can use air filtration and can be activated manually or by a circuit;
(i) a heating element, microwave, or built-in toaster, or toaster oven which can warm or toast the baked goods.
(j) an LED display to indicate the date, time, and the use of various apparatus functions, which can also be used as a light on the outside or on the inside of the apparatus;
(k) buttons to initiate apparatus functions, and to power the unit;
(l) an electrical circuit(s) and/or circuit board(s), which can be connected to various parts of the apparatus which will control various functions;
(m) electrical sensors, switches, integrated circuits, and circuit components to control the apparatus's functions;
(n) a standard 120 volt power cord to give the apparatus electrical power with means for storing or disconnecting the cord so that the apparatus can easily be moved.

6: The apparatus of claim 1, which can be or is easily washable, and equip with washable items or components, which can be comprised of:
(a) sections which are designed to slide in and out of the enclosure to function as separators for the baked goods, which can come in different shapes and sizes, and are designed to fit inside the enclosure in ways that cater to many types of baked goods or foodstuffs; which can be tapered or sharp on certain edges to function as cutting tools for the goods, which are able to be arranged in ways to be convenient;
(b) tray(s), plate(s), or cutting board(s) which is/are able to slide in and out of the apparatus to provide the user with a place to prepare the baked goods;
(c) racks or baskets designed specifically and shaped to suit different types of baked goods, which are able to be taken out and can also slide in and out of the apparatus to aid in food organization and sanitation, which are stackable and able to be neatly organized to provide enhanced organization for the apparatus;
(d) a tray(s) or basket(s) which is/are able to slide in and out of the enclosure or which can be the entire inside of the enclosure or the enclosure itself, which can be removed or detached from the enclosure or from the rest of the apparatus, which can function as a crumb catcher, which can be used to deliver the goods to other areas or so it can be emptied, to aid in sanitation, which can be conveniently stackable with other trays or baskets;

7: The apparatus of claim 1, wherein the apparatus can be or is designed to suit the highest level of baked good or foodstuff preparation, storage, convenience, and organization, which is ergonomically designed to cater to specific needs of the baked goods and/or foodstuffs, which provides sophisticated support for its contents with use of its walls and/or components, with specific contours to prevent damaged goods.

8: The apparatus of claim 1, which can be or is able to cater to the needs of multiple types of goods stored in the same unit.

9: The apparatus of claim 1, which can be or is powerful and large or sized enough to provide means for preparation, organization, and storage of substantial amounts of goods.

10: The apparatus of claim 1, wherein the apparatus can be or is sleekly and ergonomically shaped to fit efficiently onto a counter-top or table, which is efficiently compact including components, and can be portable, which is designed to be easy, easily accessible, and convenient to use, which is designed to fit efficiently and conveniently in the kitchen or similar environiment, which can be built into the kitchen or similar environment.

11: The apparatus of claim 1, which can be or is equip with a manual and/or automatic latching system, which can aid in keeping the apparatus closed and can also help to open it, which can add or apply leverage, pressure, and a popping effect between the lid and the enclosure to aid in opening the enclosure, which can aid in containing a vacuum, comprised of the following or similar components:
(a) a hook or catch to hold the system shut, which can be moved by an activator;
(b) a pin to hold the hook or catch in place to keep the system shut, which can be moved by an activator;
(c) an activator with resistance such as a button or lever, which can be pressed, pushed, or pulled to activate the movement of the hook, catch, or pin, to cause the system to open or close, which can also pop the apparatus open, which can also activate other functions of the apparatus by the use of the circuit;
(d) clasps to hold the lid shut with pressure.

12: The apparatus of claim 1, which does not make complicated environmental changes to its enclosure.

13: The apparatus of claim 1, that doesn't produce waste and is without elements which need maintenance, or that need to be changed.

14: The apparatus of claim 1, wherein the apparatus is not dependant on another apparatus or appliance.

15: The apparatus of claim 1, that doesn't need excessive knowledge, maintenance, or manipulation of the machine for its use, which is not excessively complicated to use and/or uneasy to manipulate and/or control.

16: The apparatus of claim 1, that uses power effectively and efficiently as possible, which doesn't use batteries.

17: The apparatus of claim 1, which can be or is equipped with a manual vacuum pump system, which can be built into the apparatus or connected separately which can be comprised of, but not limited to any of the following components:
(a) a vacuum activator such as a button or lever, which will be exercised to create suction to a user's preference;
(b) two cylinders, one of which will be slightly smaller in diameter and in length, which will have a rubber ring or gasket connected to the end, which will be inserted into the larger cylinder, the second cylinder of which will have a ring of holes around a section for air release, both of which will form a suction creating mechanism by the back and forth movement of the inner cylinder and rubber ring or gasket which can be exercised by the vacuum activator;
(c) a unidirectional valve connected to the end of the larger cylinder to provide a way for air intake;
(d) an automated air valve connected to the side of the larger cylinder to provide a port for air flow, so that the pump can continue to be exercised without resistance;
(e) a unidirectional air valve built into the enclosure to allow an external vacuum source to be connected to the apparatus.

18: The apparatus of claim 1, wherein the apparatus can be or is equally effective without the use of a vacuum pump.

19: The apparatus of claim 1, wherein the apparatus and its components can come in different shapes and styles.

20: The apparatus of claim 1, wherein the apparatus can be or is made out of plastic, acrylic, metal, glass, cardboard, or wood.
